(19) United States
(12) Patent Application Publication
(10) Pub. No.: US 2014/0177235 A1
(43) Pub. Date: Jun. 26, 2014

(54) OPTICAL LENS AND LIGHTING DEVICE HAVING THE SAME

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/060,602

(22) Filed: Oct. 22, 2013

(30) Foreign Application Priority Data
Dec. 26, 2012 (TW) 101150011

(51) Int. Cl. F21V 5/04; F21K 99/00

(52) U.S. Cl. CPC F21V 5/046; F21K 9/50
USPC 362/311.02; 362/332

(57) ABSTRACT

An optical lens includes a light incident surface, a light emitting surface, and a side surface between the light incident surface and the light emitting surface. The light emitting surface is a convex and curved surface opposite to the light incident surface. The light incident surface defines a receiving chamber. The receiving chamber is cone-shaped and concave in a direction from the light incident surface toward the light emitting surface. The side surface has a rugged structure and is a frosted surface to diffuse light therethrough. A lighting device having the optical lens is also provided.

### BACKGROUND

1. Technical Field

The disclosure generally relates to an optical lens, and particularly relates to an optical lens with a uniform lighting distribution performance and a lighting device having the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, the light intensity of a light emitting diode gradually decreases from a middle portion to lateral sides of the light emitting diode. Such a feature makes the LED unsuitable for functioning as a light source which needs a uniform illumination, for example, a light source for a direct-type backlight module for a liquid crystal display (LCD). It is required to have an optical lens which can help the light from a light emitting diode to have a wider illumination angle and a uniform lighting distribution.

What is needed, therefore, is an optical lens and a lighting device having the optical lens to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an optical lens in accordance with an embodiment of the present disclosure.

FIG. 2 is a cross sectional view of the optical lens in FIG. 1.

FIG. 3 is an enlarged view of a part II in FIG. 2.

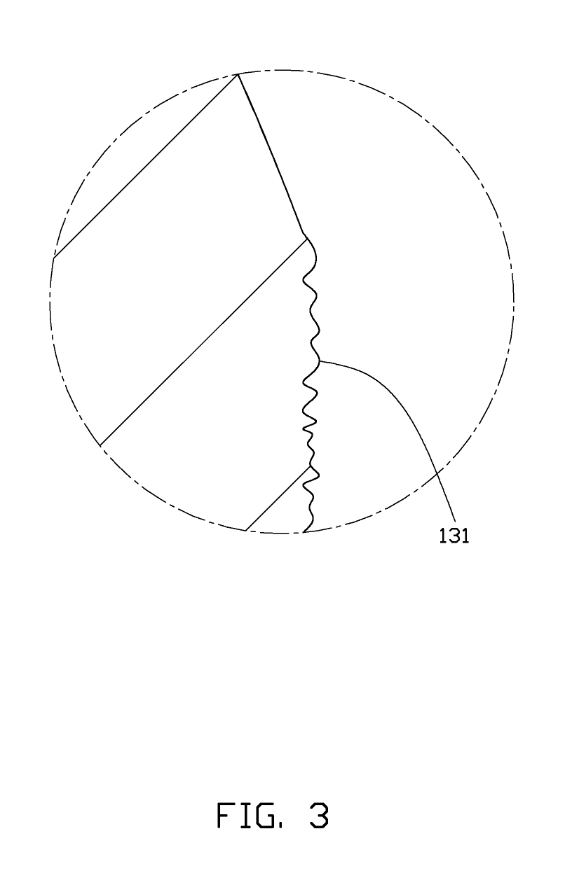

FIG. 4 is a cross sectional view of a lighting device having the optical lens in FIG. 1.

### DETAILED DESCRIPTION

Embodiments of an optical lens and a lighting device will now be described in detail below and with reference to the drawings.

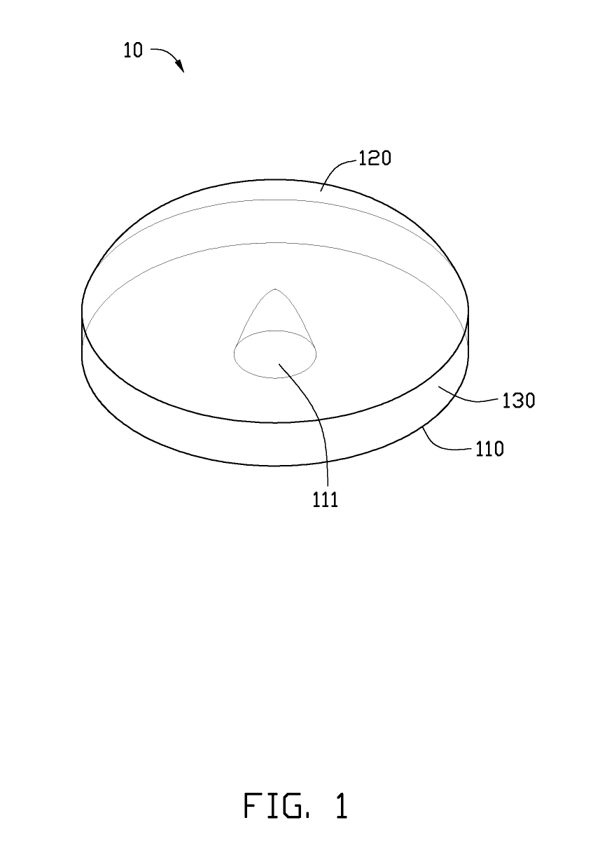

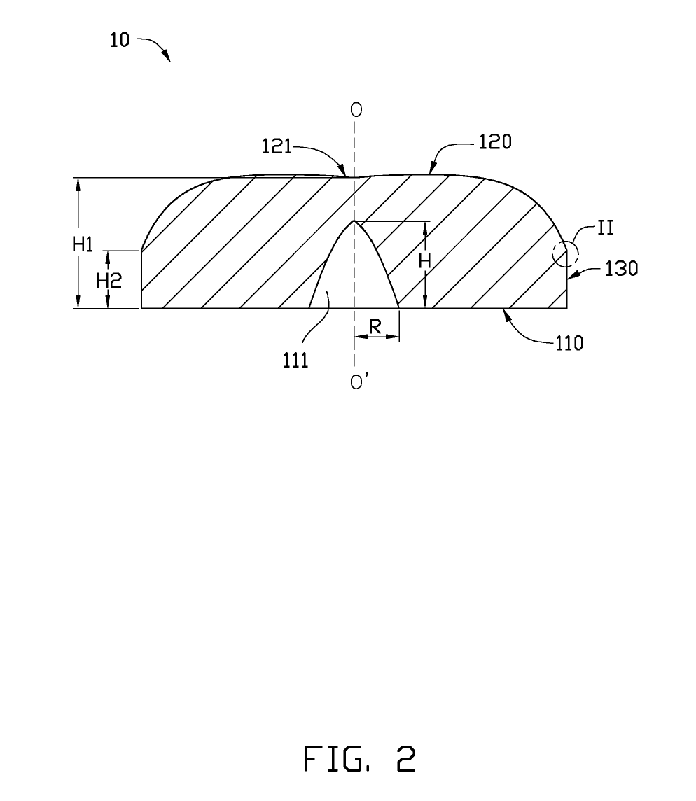

Referring to FIGS. 1-2, an optical lens 10 in accordance with an embodiment is provided. The optical lens 10 includes a light incident surface 110, a light emitting surface 120 and a side surface 130 connected between the light incident surface 110 and the light emitting surface 120. The optical lens 10 is made of a material selected from polycarbonate (PC), polymethyl methacrylate (PMMA) and glass, which is transparent. In this embodiment, the optical lens 10 has an optical axis OO′. The optical lens 10 is axisymmetric with respect to the optical axis OO′.

The light incident surface 110 is a circular, flat surface. The light incident surface 110 defines a receiving chamber 111 in a middle portion thereof. The receiving chamber 111 is cone-shaped and concaved from light incident surface 110 toward the light emitting surface 120. In this embodiment, the receiving chamber 111 is coaxial with the optical lens 10. The optical axis OO′ extends through centers of the optical lens 10 and the receiving chamber 111. In this embodiment, a distance H between a vertex of the receiving chamber 111 and the light incident surface 110 is larger than a radius R of a bottom of the receiving chamber 111. The distance H between the vertex of the receiving chamber 111 and the light incident surface 110 is larger than half of a distance between the light emitting surface 120 and the light incident surface 110, wherein the distance is equal to a thickness of the lens 10. When light is emitted into the optical lens 10 from the receiving chamber 111, light will be refracted and emit in a direction away from the optical axis OO′.

The light emitting surface 120 is convex in a direction away from the light incident surface 110. In this embodiment, the light emitting surface 120 defines a recess 121 in a middle portion of the light emitting surface 120. The recess 121 is concave from the light emitting surface 120 toward the light incident surface 110. In this embodiment, the distance H between the vertex of the receiving chamber 111 and the light incident surface 110 is larger than half of a distance H1 between a central point of the light emitting surface 120 and the light incident surface 110.

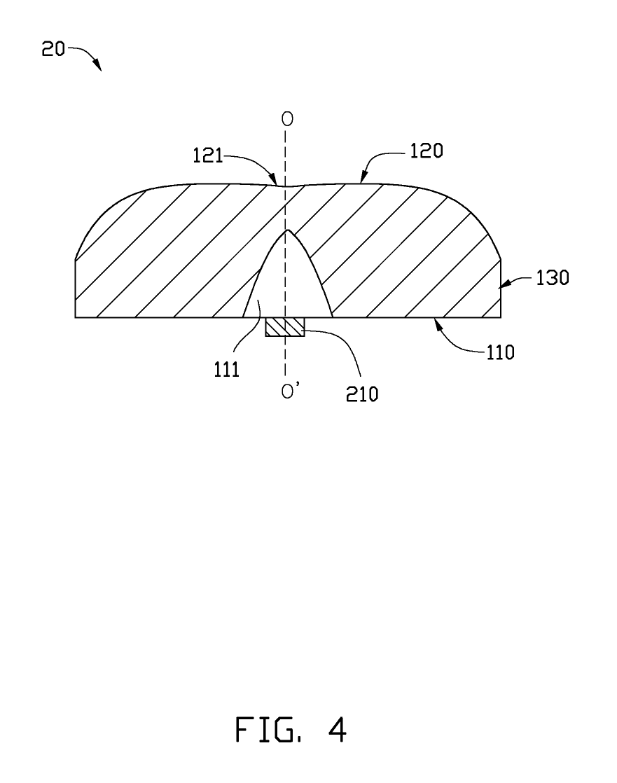

The side surface 130 is connected between the light incident surface 110 and the light emitting surface 120. Referring also to FIG. 4, the side surface 130 has a rugged structure 131 to make light being diffused in the side surface 130 when the light leaves the lens 10 from the side surface 130. In this embodiment, the rugged structure 131 of the side surface 130 is formed by treating the side surface 130 with sandblasting or electrical discharge machining whereby the side surface 130 becomes a frosted surface. The side surface 130 is perpendicular to the light incident surface 110. A height H2 of the side surface 130 is less than the distance H between the vertex of the receiving chamber 111 and the light incident surface 110.

FIG. 4 shows a lighting device 20 having the optical lens 10. The lighting device 20 includes the optical lens 10 and a light emitting diode 210. The light emitting diode 210 is located at a side of the light incident surface 110 away from the light emitting surface 120. The optical axis OO′ extends through a center of the light emitting diode 210. A light emission surface of the light emitting diode 210 is flush with the light incident surface 110. Light from the light emitting diode 210 emits into the optical lens 10 from the receiving chamber 111 and the light incident surface 110 of the optical lens 10 defining the receiving chamber 111, and emits out of the optical lens 10 from the light emitting surface 120 and the side surface 130.

In the optical lens 10 and the lighting device 20 described above, since the light incident surface 110 defines a receiving chamber 111, and the receiving chamber 111 has a cone-shaped and concave toward the light emitting surface 120, when light of the light emitting diode 210 emits into the optical lens 10 from the receiving chamber 111, the light will be refracted by the receiving chamber 111 and emits in a direction away from the optical axis OO′. Therefore, a viewing angle of the lighting device 20 is increased. In addition, because the viewing angle of the lighting device 20 is increased, more light will emit out of the optical lens 10 from the side surface 130. By forming rugged structure on the side surface 130, the rugged structure will diffuse light emitting to the side surface 130. Therefore, a uniform light distribution is achieved.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical lens, comprising:
a light incident surface;
a light emitting surface, the light emitting surface being a convex and curved surface opposite to the light incident surface; and
a side surface interconnecting the light incident surface and the light emitting surface;
wherein the light incident surface defines a receiving chamber configured for receiving light from a light source, the receiving chamber is cone-shaped and concave in a direction from the light incident surface to the light emitting surface, and the side surface has a rugged structure and is a frosted surface, configured for diffusing the light from the light source and through the side surface.

2. The optical lens of claim 1, wherein a distance between a vertex of the receiving chamber and a bottom of the receiving chamber is larger than a radius of the bottom of the receiving chamber.

3. The optical lens of claim 1, wherein the light emitting surface defines a recess in a middle portion thereof, and the recess is concave from the light emitting surface to the light incident surface.

4. The optical lens of claim 1, wherein the light incident surface is a flat surface.

5. The optical lens of claim 4, wherein the side surface is perpendicular to the light incident surface.

6. The optical lens of claim 5, wherein the side surface has a height less than a distance between a vertex of the receiving chamber and the light incident surface.

7. The optical lens of claim 4, wherein a distance between a vertex of the receiving chamber and the light incident surface is larger than half of a distance between a central point of the light emitting surface and the light incident surface.

8. A lighting device, comprising:
an optical lens comprising a light incident surface, a light emitting surface, and a side surface interconnecting the light incident surface and the light emitting surface, the light emitting surface being a convex and curved surface opposite to the light incident surface, the light incident surface defining a receiving chamber, the receiving chamber being cone-shaped and concave in a direction from the light incident surface toward the light emitting surface, the side surface having a rugged structure and being a frosted surface capable of diffusing light radiating therethrough; and
a light emitting diode located at a side of the light incident surface away from the light emitting surface, light from the light emitting diode emitting into the optical lens via the receiving chamber and the light incident surface defining the receiving chamber, and emitting out of the optical lens via the light emitting surface and the side surface, the light emitting out of the optical lens via the side surface being diffused by the side surface.

9. The lighting device of claim 8, wherein a distance between a vertex of the receiving chamber and a bottom of the receiving chamber is larger than a radius of the bottom of the receiving chamber.

10. The lighting device of claim 8, wherein the light emitting surface defines a recess in a middle portion thereof, and the recess is concave from the light emitting surface toward the light incident surface.

11. The lighting device of claim 8, wherein the light incident surface is a flat surface.

12. The lighting device of claim 11, wherein the side surface is perpendicular to the light incident surface.

13. The lighting device of claim 12, wherein the side surface has a height less than a distance between a vertex of the receiving chamber and the light incident surface.

14. The lighting device of claim 11, wherein a distance between a vertex of the receiving chamber and the light incident surface is larger than half of a distance between a central point of the light emitting surface and the light incident surface.

15. The lighting device of claim 8, wherein the optical lens has an optical axis, and the optical axis extends through a center of the light emitting diode.
